(19) United States
(12) Patent Application Publication
(10) Pub. No.: US 2002/0138156 A1
(43) Pub. Date: Sep. 26, 2002

(54) System of connecting multiple processors in cascade

(76) Inventors: Isaac H. Wong, Fremont, CA (US); Jiinyuan Lee, San Jose, CA (US)

Correspondence Address: Jon W. Hallman, SKJERVEN MORRILL MacPHERSON LLP, Suite 700, 25 Metro Drive, San Jose, CA, 95110-1349, US

(21) Appl. No.: 09/772,112

(22) Filed: Jan. 25, 2001

(51) Int. Cl. G05B 15/02

(52) U.S. Cl. 700/8

(57) ABSTRACT

A multiprocessor system uses a master processor coupled to a ROM device to transfer boot code to slave processors over a bus. The memory controllers in the slave processors are controlled to deny processor memory request until the boot code has been transferred to their RAM devices. The memory controllers map the transferred boot codes to a first address space in their RAM devices.

### FIELD OF THE INVENTION

The present invention relates generally to the field of initializing processors. More specifically, the present invention relates to methods and apparatus for initializing slave processors in a multiprocessor system.

### DESCRIPTION OF RELATED ART

When a microprocessor is powered-up, its central processing unit (CPU) resets and reads an instruction from a specific hard-wired memory address, generally located in a ROM device. This hard-wired address will be the first instruction in a series of instructions known as the boot code that the CPU uses to initialize itself. During this initialization, a set of programs known as the operating system will be copied from the ROM device or from a hard disc into a RAM coupled to the CPU. The final instructions from the ROM device will command the CPU to pass control to the operating system. This initialization process prior to control by the operating system is typically known as a “boot” procedure.

The boot procedure becomes more complicated in a multiprocessor system, having two main approaches. In the first approach, each CPU in the multiprocessor system has its own ROM for storing a copy of its boot code. Because the CPUs are typically the same and the boot codes are largely identical, this approach suffers from needlessly storing similar copies of the boot code, thereby increasing memory costs. In a second approach, a single boot code is used by a specialized or master processor to boot-up the remaining processor through a handshaking procedure. Although this approach reduces boot code storage space, it suffers from requiring specialized hardware to coordinate the handshaking.

There is a need in the art for a bootstrap procedure in a multiprocessor system that efficiently uses memory with a minimum of specialized hardware.

### SUMMARY

In accordance with the invention, a master processor couples to a slave processor through a bootstrap bus for transmitting boot code. The master processor commands the memory controller of the slave processor to deny processor memory requests while boot code is being transmitted over the bootstrap bus. The transferred boot code is mapped to a first address space in a RAM device coupled to the memory controller.

The invention will be more fully understood upon consideration of the detailed description below, taken together with the accompanying drawings.

### BRIEF DESCRIPTION OF THE DRAWINGS

FIG. 1 illustrates a master/slave bootstrap architecture according to one embodiment of the invention.

FIG. 2 illustrates, for the master processor and one slave processor from FIG. 1, the arrangement of the cascade bootstrap interface modules.

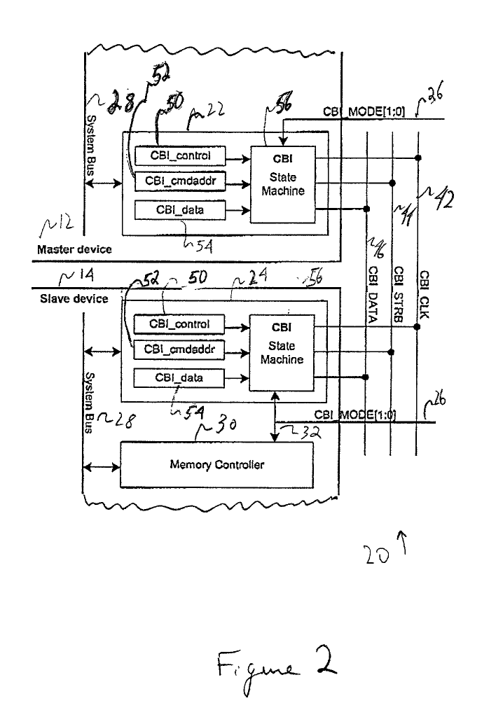

FIG. 3 illustrates a memory mapping using a single chip-select.

FIG. 4 illustrates a memory mapping using two chip-selects.

FIG. 5 illustrates a timing diagram for the signals carried on the bootstrap bus according to one embodiment of the invention.

Use of the same reference symbols in different figures indicates similar or identical items.

### DETAILED DESCRIPTION

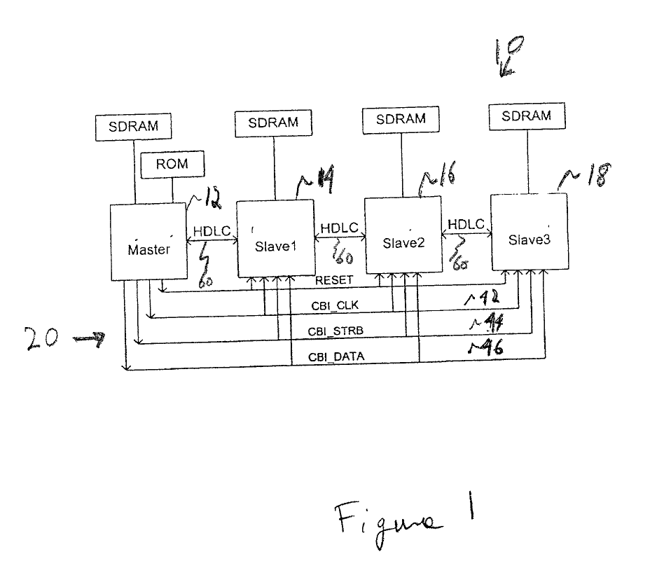

Referring now to FIGS. 1 & 2, a master/slave architecture 10 for implementing one embodiment of the invention is illustrated. A master processor 12 has both a ROM device and a synchronous-dynamic RAM (SDRAM). Using the ROM device, the master processor 12 may boot-up in the conventional fashion previously discussed. However, slave processors 14, 16, and 18 do not have ROM devices for storing boot code but instead possess only SDRAM devices. Thus, these processors cannot boot in a conventional manner. Instead, their boot code will be transmitted by the master processor 12 to the individual slave processors over a cascade bootstrap bus 20.

The processors couple to the bootstrap bus 20 through a bootstrap interface module. The details of the bootstrap interface module will be discussed further below. To minimize hardware requirements, the communication over bootstrap bus 20 may be one-way: from the master processor 12 to the slave processors. Thus, the master bootstrap interface module 22 is shown transmitting signals to the bootstrap bus 20, whereas the slave bootstrap interface module 24 is shown receiving signals from the bootstrap bus 20.

Although the hardware in the bootstrap interface modules 22 and 24 may be specialized for either a master or a slave role, a bootstrap interface module must identify its role upon power-up to permit a generic construction for either role. A generic construction provides a user flexibility in assigning slave and master roles to processors. In a generic construction, the bootstrap interface module doesn't know at power-up whether it is a slave or a master. Thus, the bootstrap interface module receives an identification signal 26 indicating its role as either master or slave. Because there is only one master processor, only a single type of “master” identification signal need be provided. However, because an arbitrary number of slave processors may require different boot codes, each slave processor should be uniquely identified. The number of bits in the identification signal 26 should be adequate to support uniquely identifying each slave. For example, in an embodiment of the invention having four slave processors, the identification signal should be two bits to uniquely identify the master and the three slaves. For such an embodiment, the identification signal 26 may couple to the bootstrap interface module through two pins (not illustrated) of the integrated circuit containing the device. The pins would either be grounded or brought high to identify the bootstrap interface module.

At power-up, a bootstrap interface module receives the identification signal 26 and determines its role. Each bootstrap interface module couples to a system bus 28 so that the module may configure a memory controller 30 within the respective processors. Should the bootstrap interface module be a slave bootstrap interface module 24, it configures its memory controller 30 to deny processor memory requests. On the other hand, should the bootstrap interface module be a master bootstrap interface module 22, it configures its memory controller 30 to accept processor memory requests. Only minor modifications/extensions to a typical memory controller design are necessary to permit a bootstrap interface module to configure it. Because MIPS-based processors are popular in networking applications and often used in a multiprocessor configuration, the modifications and following description will address a MIPS environment. However, the principles of the invention are readily adaptable for other types of processors.

The memory controller used in the invention supports multiple client modules (not illustrated). These client modules include embedded CPU cores, DSP and I/O peripheral modules. The client modules submit requests to the memory controller 30 when they require memory read/write accesses to external memory. The memory controller 30 has a memory-request-enable register (MEM_REQ_EN) (not illustrated). This register is part of the mechanism by which memory requests by the client modules can be enabled or disabled. Each client module has a bit in the MEM_REQ_EN register associated with it. The memory controller 30 allows memory access by those client modules whose enable bit in the MEM_REQ_EN register is set to logical “1.” If the enable bit is set to logical “0,” the memory controller 30 denies memory access from that client module. For the master processor 12, the bits in the MEM_REQ_EN register are set to all 1's on power-up, allowing the request by its embedded CPU to fetch the boot code from its ROM device. For the slave processors, the bits in the MEM_REQ_EN register are set to all 0's except for the enable bit of the slave bootstrap interface module 24. This bit setting blocks any memory requests by the embedded CPUs in the slave processors, preventing the slave CPUs from fetching their boot code. After the master processor has finished downloading the boot code into the slave processors' SDRAM devices, the bits in the MEM_REQ_EN register may be set to all 1's to enable memory accesses, for example, by the slave processors' CPUs. Note that the embedded CPU core in the slave processor requires no modification in its boot mechanism (as defined by its hardware and software). Indeed, as far as the slave processor is concerned, it is booting normally. The embedded CPU core in a slave processor has no knowledge that its request for boot code is being blocked (delayed) while the boot code is being downloaded into its external memory by the master processor. This is advantageous because changes to the CPU boot mechanism are typically difficult and expensive to implement.

The memory controller 30 may support up to 8 external memory devices. When the memory controller 30 needs to access a particular external memory device it asserts a chip-select (CS) signal coupled to that memory device. The memory controller 30 has 8 memory base address and mask registers (MEM_BA) (not illustrated), each associated with a respective chip-select signal. The MEM_BA registers define the base address and size of the external memory devices. By using the values programmed into these MEM_BA registers, the memory controller 30 determines which external memory device contains the address requested by a client module such as the processor's embedded CPU. Thus, given a particular memory request, the MEM_BA registers determine which chip-select to use. For the master processor 12, two of these MEM_BA registers will be set, on power-up, to default values. One of these MEM BA registers allows the MIPS boot address 0x1fc0_0000 to be mapped to the master's ROM device. Similarly, the starting address of the interrupt/exception handler is 0x0000_0080 in a MIPS processor. The remaining MEM_BA register maps this memory request to the master processor's SDRAM device. For the slave processors 14, 16, and 18, the master processor sets corresponding MEM_BA registers using the bootstrap interface modules and the bootstrap bus 20.

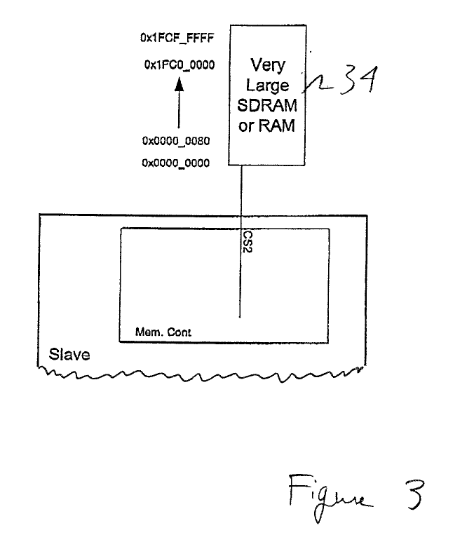

When a MIPS processor executes an interrupt it will always branch to the address of the interrupt/exception handler, which is 0x0000_0080 as defined by the MIPS architecture. The starting address of the boot code in ROM is very different: 0x1fc0_0000. If both the starting boot code address and the interrupt/exception handler address are mapped using a single chip-select (e.g., CS2) and its MEM_BA register, a very large SDRAM or RAM device 34 is required as seen in FIG. 3. This SDRAM or RAM device 34 must allow for gigabytes of storage to cover the large range between these addresses. Although this is feasible, it requires an unnecessarily large RAM device 34 that may be very expensive.

A preferred solution for the slave processors configures their memory controllers to internally OR two separate chip-selects onto a single output pin. The MEM_BA registers corresponding to the two chip- selects are configured such that the starting ROM address and the exception/interrupt handler address map to the same address space in the SDRAM device. For example, chip-select 2 (CS2) and chip-select 7 (CS7) could both be ORed to a single output pin coupled to the slave processor's SDRAM device. Accordingly, the master processor 12 configures the corresponding MEM_BA registers, MEM_BA2 and MEM_BA7, appropriately using the bootstrap interface modules 22 and 24 and the bootstrap interface bus 20. An understanding of the appropriate configuration of these registers requires a discussion of their respective bit fields.

The MEM_BA2 register's bit field is defined as:

| Bit Field | Description | R/W | default |
|---|---|---|---|
| 0 | Valid bit for CS2 | R/W | 0 |
| 9:1 | Address Mask [31:23] for CS2 | R/W | |
| 18:10 | Base Address [31:23] for CS2 | R/W | |

Similarly, the MEM BA7 register's bit field is defined as:

| Bit Field | Description | R/W | default |
|---|---|---|---|
| 0 | Valid bit for CS7 | R/W | 0 |
| 12:1 | Address Mask [31:20] for CS7 | R/W | |
| 24:13 | Base Address [31:20] for CS7 | R/W | |

Note that the base address and mask values define only the upper bits of their 32-bit values. The lower bits are assumed to be zero. For example in the MEM_BA2 register, setting the address mask value to 0x1ff actually indicates a 32-bit mask value of 0xff80_0000 because this mask value represents only bits 23 through 31 of the full 32-bit address mask. Mapping both the starting address of the exception/interrupt handler and the starting address of the ROM boot code to the same address space requires that the base address and mask values be configured by the master processor as follows:

| Bit Field | Value | Description |
|---|---|---|
| MEM_BA2:address mask | ′b1111_1111_1 | For phy.Address |
| | | 0x0000_0000 and up |
| MEM_BA2:base address | ′b0000_0000_0 | For phy.Address |
| | | 0x0000_0000 and up |
| MEM_BA7:address mask | ′b1111_1111_1111 | For phy.Address |
| | | 0x1fc0_0000 and up |
| MEM_BA7:base address | ′b0001_1111_1100 | For phy,Address |
| | | 0x1fc0_0000 and up |

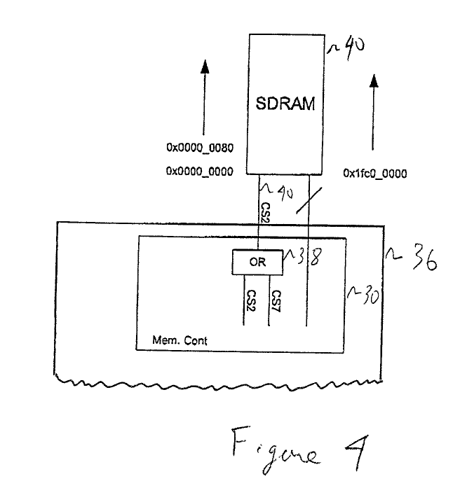

Referring now to FIG. 4, the resulting mapping is illustrated. Bootstrap memory requests from the master processor 12 are mapped to CS7 by the memory controller 30. Note that as used herein, a “memory request shall denote either a read request or a write request. After the slave processor has booted, its processor memory requests are mapped to CS2 by the memory controller 30. These two chip-selects are internally ORed at OR gate 38 onto the external CS2 pin 40. This pin couples to the SDRAM device 40. Note the marked savings in memory over the embodiment of the invention illustrated in FIG. 3 because the address space for boot code, starting at 0x1fc0_0000 overlaps with the address space for operating RAM storage starting at the interrupt/exception handler address of 0x0000_0080. A block of memory starting at 0x0000_0080 is reserved for the exception/interrupt handler. In one embodiment of the invention, the address range below the MIPS exception vector address 0x0000_0080 (0x0000_0000 through 0x0000_007F) stores the beginning segment of the boot code for the slave processor. This segment of the boot code typically contains a branch instruction to branch to other segments of the boot code located at other memory locations.

If a generic construction is desired for the memory controller 30 for both master and slave processors, the OR gate for the two chip-selects may be made configurable. A default programming value would disable the configurable OR gate such that the master processor's memory controller would not OR any chip-select signals. During the configuration of the slave processor's memory controller 30 by the master processor 12, the configurable OR gate would not be disabled so the appropriate chip-select signals are ORed. Alternatively, a generic construction for the memory controllers may be avoided by simply permanently ORing the appropriate chip-selects in the slave processors' memory controllers.

The cascade bootstrap bus 20 may consist of only three lines: a line 42 for carrying the bootstrap clock, a line 44 for carrying the bootstrap strobe, and a line 46 for carrying the bootstrap data signal. These signals are propagated in a one-way fashion from the master processor 12 to the slave processors 14, 16, 18, acting to send a 32-bit address/command word and a 32-bit data word sequentially on the data signal line 46 to the slave bootstrap interface modules 24. The bootstrap strobe signal carried on line 42 denotes the beginning of address/data word pair. The signals are latched at the slave bootstrap interface modules 24 according to the bootstrap clock signal carried on line 42.

Similar to the bootstrap bus 20, each bootstrap interface module may comprise a minimum of hardware, each having three registers: a bootstrap control register 50, an address/command register 52, and a data register 54. These registers interact with a bootstrap state machine 56 within each module that will be further described herein.

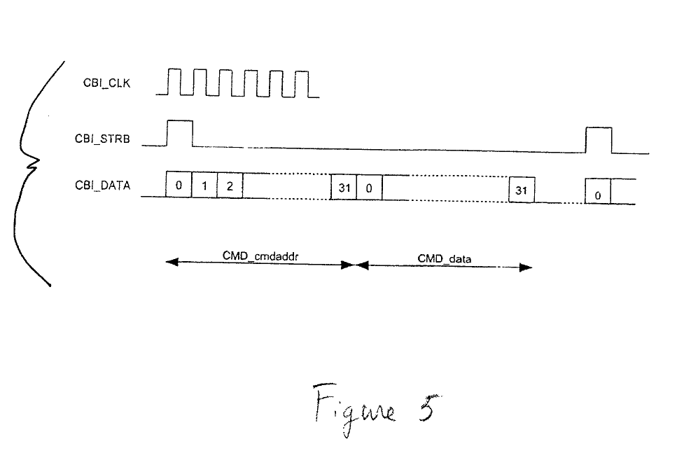

Referring now to FIG. 5, a timing diagram for the signals on the bootstrap bus 20 is illustrated. The clock strobe signal signifies the start of the transmission of a 64-bit command/address and data signal 32-bit word pair. Both the command/address signal and the bootstrap data signal are stable on the falling edge of the bootstrap clock signal. The master bootstrap interface module 22 sets up the bootstrap data signal and the address/command signal on the rising edge of the bootstrap clock signal. Similarly, the slave bootstrap interface module 24 reads the bootstrap data signal the address/command signal on the falling edge of the bootstrap clock signal. Note that the choice of either a rising or falling edge clock signal is arbitrary and may be altered.

The bootstrap interface module 24 in the slave processors may read and write to control registers coupled to the system bus 28. These control registers include the control and configuration registers of the memory controller (such as MEM_REQ_EN and MEM_BA register discussed earlier). The master processor 12 would first use its bootstrap interface module 22 and the bootstrap bus 20 to send commands to configure the relevant configuration registers of the slave processor memory controller.

The bootstrap bus 20 supports 3 commands for the master processor 12 to: 1) write to a slave processor's internal control registers, 2) write to a slave processor's external memory and 3) command the slave bootstrap interface module 24 to suspend operation (CBI_finish command).

Typically the master processor 12 would use the control register write command to configure the memory controller's configuration registers in each slave processor. Then it will use the memory write command to write the boot code into the external memory (typically an SDRAM device) of each slave processor. It will then use the control register write command to set the MEM_REQ_EN register in slave processor to all 1's followed by a CBI_finish command. Finally, note that the bootstrap bus 20 is a point-to-multi-point bus with respect to transmission from the master to the slave processors. In many instances, the slaves may all be identical, in which case each requires the same boot code. For such a multiple processor system, the master bootstrap interface module 22 need only broadcast simultaneously to all slave processors at once. However, there are circumstances, such as where the slave processors are different, wherein the master bootstrap module 22 must transmit to a particular slave bootstrap interface module 24. Thus, the command/address signal preferably has a bit field dedicated to a slave select signal that may either select all the slaves (broadcast mode) or a particular slave bootstrap interface module 24. An example configuration for these bit fields in the address/command register 52 is as follows:

| Bit Field | Name | R/W | Default | Description |
|---|---|---|---|---|
| 31:28 | Slave_sel | R/W | 0 | Slave device select |
| | | | | 0: broadcast message— |
| | | | | for all slave devices |
| | | | | 1: message for slave 1 |
| | | | | 2: message for slave 2 |
| | | | | 3: message for slave 3 |
| | | | | 4-15: reserved |
| 27:2 | Addr1 | R/W | 0 | Bits[27:2] of the control |
| | | | | register address or memory. |
| | | | | Automatically post increment by |
| | | | | 1 after every transmit. |
| 1:0 | Command | R/W | 0 | ′b00: Memory_write |
| | | | | ′b01: control register_write |
| | | | | ′b10: finish |
| | | | | ′b11: reserved |

After properly seeding the SDRAM devices of slave processors using memory write commands, the master bootstrap interface module 22 will issue a finish command. Prior to issuing the finish command, the master bootstrap interface module 22 issues a control register write command to set the MEM_REQ_EN register in the slave's memory controllers to all 1's. This will enable the CPU's memory requests that has been blocked since power-up. The finish command puts the slave bootstrap interface module 24 into a suspend mode to save power. Note that the address/command register 52 may be configured to automatically post increments by 1 in the address field to facilitate sequentially writing data words to contiguous memory locations during the memory seeding process.

The control register 50 in the bootstrap interface module allows the clock speed of the bootstrap bus 20 to be set as well as status information indicating the state of the bootstrap interface module. In one embodiment, the clock speed of the bootstrap bus 20 can be set to ¼^{th} or ⅛^{th} of the system clock speed of between of 100 MHz and 133 MHz. By setting the clock speed of the bootstrap bus 20 to such speeds, ample time is provided for the completion of a particular write operation before the next 64-bit address/command and data word is sent on the bootstrap bus 20. The status bits indicate whether the bootstrap interface module is busy transmitting to the slave processor. The bit-field contents for the control register 50 may thus be as follows:

| Bit Field | Name | R/W | Default | Description |
|---|---|---|---|---|
| 31:30 | Istate | R/W | ′b11 | ′b00: run |
| | | | | ′b01: reserved, |
| | | | | ′b10: reset. |
| | | | | ′b11: halt (default) |
| 29:2 | Reserved | R | 0 | |
| 1 | clkdiv | R/W | 0 | 0: CBI_CLK rate is system |
| | | | | clock/4 |
| | | | | 1: CBI_CLK rate is system |
| | | | | clock/8 |
| 0 | busy | R | 0 | 0: CBI not transmitting |
| | | | | 1: CBI transmitting on |
| | | | | CBI_DATA |

The data register 54 in the master bootstrap interface module 22 contains data to be written to the slave processor. The software in the master processor 12 will normally first write the appropriate value into the command/address register 52 followed by a write to the data register 54. Every write to the data register 54 will trigger the master bootstrap interface module 22 to start the transmit operation. The transmit operation simply involves sequentially shifting the data hits in the command/address 52 and data registers 54 onto the bootstrap data line 46 in the bootstrap bus 20 bit by bit. Every transmit operation is started with the master bootstrap interface module 22 asserting the strobe signal (CBI_STRB) for one clock cycle.

In the slave bootstrap interface module 24, two sets (only one set is illustrated) of command/address 52 and data registers 54 may be used to receive the data transmitted by the master processor 12. These two register sets are used in a “ping-pong” fashion. Such an embodiment allows the slave bootstrap interface module 24 to receive data over the bootstrap bus 20 while a previously-transmitted address/command and data word pair are being executed.

At a bootstrap clock rate of 25 MHz and a system clock rate of 100 MHz, it will take 256 system clock cycles for a new set of address/command and data word pair to arrive at the slave bootstrap interface module. Such a period of system clock cycles provides ample time for the completion of the previous memory or control register write operation.

The bootstrap state machines 56 are quite simple. For example, the main function of the state machine 56 in the master bootstrap interface module 22 is to shift the data in the address/command register 52 and the data register 54 onto the data signal line 46. For a slave device, the primary function of the state machine 56 is to shift the serial data received on the data signal line 46 into its address/command register 52 and data register 54 and execute the commands discussed with respect to the address/command register 52.

A sample bootstrap procedure may be summarized as follows:

1. The master processor 12 comes out of reset at power-up and boots from the ROM device normally.

2. The slave processors come out of reset at power-up and identify themselves as slaves. The slave bootstrap interface modules 24 configure their memory controllers 30 to deny processor memory requests. Because the processor memory request are denied, when the slave CPUs come out of reset and request their first instruction from ROM, no memory fetch is returned. The slave CPUs will then stall at this instruction fetch.

3. The master bootstrap interface module 22 sets the MEM_BA2 and MEM_BA7 registers in the slave memory controllers 30 to reflect a base address of 0x0000_0000 and 0x1fc0_0000, respectively.

4. The master bootstrap interface module transfers the boot image to the slave's SDRAM devices using the memory write command. The contents of the boot code designated for 0x1fc0_0000 through 0x1fc0_007f are written to 0x0000_0000 through 0x0000_007f. These addresses are mapped to the same memory cells in the SDRAM devices.

5. The master bootstrap interface module sets the MEM_REQ_EN registers in the slave memory controllers to 1's and issues the finish command to halt the bootstrap interface modules in the slaves.

6. The slave processors 12, 14, and 16 may now operate normally (processor memory requests are honored) and begin fetching the first “ROM” instruction at 0x1fc0_0000 from the SDRAM devices. The slave processors can then boot.

7. The slave processors 12, 14, and 16 may then signal over the HDLC interface 60 that they are running normally.

8. The master bootstrap interface module 22 shuts down the bootstrap bus 20 by tri-stating its pins.

Note the advantages provided by this bootstrap procedure. No hardware changes are necessary in the CPU cores—they act as if they are still coupled to both a ROM and an SDRAM device for an ordinary boot procedure. The bootstrap bus 20 requires only three pins for each processor. Similarly, the hardware required by the bootstrap interface modules is minimal.

Although the invention has been described with reference to particular embodiments, the description is only an example of the invention's application and should not be taken as a limitation. For example, although described with respect to MIPS-based processors, the invention is equally applicable to other types of processors. Consequently, various adaptations and combinations of features of the embodiments disclosed are within the scope of the invention as defined by the following claims.

I claim:

1. A method of initializing for a system having a master processor and at least one slave processor, wherein each processor includes a memory controller associated with a RAM device, the memory controller of the master processor also being associated with a ROM device for storing boot code; the memory controllers being coupled to a bus, comprising:
initializing the master processor using the boot code in the ROM device;
configuring the memory controller of the slave processor to deny processor memory requests;
(a) transferring boot code from the ROM device to the memory controller of the slave processor using the bus, the memory controller mapping the transferred boot code to a first address space in its RAM device;
(b) configuring the memory controller of the slave processor to grant processor memory requests; and
(c) using the transferred boot code, initializing the slave processor.

2. The method of claim 1, wherein the at least one slave processor comprises a plurality of slave processors.

3. The method of claim 1, further comprising:
after initializing the slave processor in act (c), receiving processor memory requests at the memory controller of the initialized slave processor, the memory controller mapping the processor memory request to a second address space in its RAM device.

4. The method of claim 31 wherein the first address space and the second address space are substantially the same.

5. The method of claim 4, wherein the processors are MIPS-based processors.

6. The method of claim 1, wherein act (a) comprises:
transmitting, on the bus, a strobe signal from the master processor,
transmitting, on the bus, a bootstrap clock signal from the master processor; and
transmitting, on the bus, a word of boot code data, wherein the strobe signal indicates the start of the word and wherein the word is latched by the slave processor according to the bootstrap clock signal.

7. The method of claim 6, wherein the master processor and the slave processors identify themselves as master or slave upon resetting by receiving an identification signal.

8. A multiprocessor system, comprising:
a bus having a data line, a strobe line for carrying a strobe signal, and a clock line for carrying a clock signal;
a master processor coupled to the bus, wherein the master processor is configured to serially transmit boot code words over the data line; and
a slave processor coupled to the bus, the slave processor including a data register, the slave processor being configured to receive the serially transmitted boot code words, wherein the start of a boot code word is indicated by the strobe signal and a received boot code word is serially shifted into the data register according to the clock signal.

9. The multiprocessor system of claim 8, wherein the master processor is configured to transmit commands over the data line, the slave processor including a memory controller for controlling a RAM device, the memory controller being configured to refuse processor memory requests.

10. The multiprocessor system of claim 9, wherein the memory controller is further configured to map the transferred boot code words to a first address space in the RAM device and to map processor memory requests to a second address space in the RAM device.

11. The multiprocessor system of claim 10, wherein the first address space and the second address space are substantially the same.

12. The multiprocessor system of claim 10, wherein the master processor and the slave processor are MIPS-based processors.
